(19) United States
(12) Patent Application Publication
(10) Pub. No.: US 2007/0079321 A1
(43) Pub. Date: Apr. 5, 2007

(54) Picture tagging

(75) Inventor: Edward Stanley Ott IV, Palo Alto, CA (US)

Correspondence Address: James J. DeCarlo;GREENBERG TRAURIG, LLP, MetLife Building, 200 Park Avenue, New York, NY, 10166, US

(73) Assignee: Yahoo! Inc., Sunnyvale, CA (US)

(21) Appl. No.: 11/357,256

(22) Filed: Feb. 17, 2006

Related U.S. Application Data
(60) Provisional application No. 60/722,600, filed on Sep. 30, 2005.

(51) Int. Cl. H04H 9/00; H04N 7/16; G06F 15/00; G06F 17/00

(52) U.S. Cl. 725/18; 725/19; 715/500.1; 715/501.1; 725/135

(57) ABSTRACT

A system and method for tagging discrete locations and/or sections within a pre-existing media file with images without modifying the media file are disclosed. The system includes a rendering device that receives user tag selections and creates information that can be used when rendering the media file in the future. When a tagged media file is rendered by a device capable of interpreting the information, the images are concurrently displayed on the interface of the rendering device. The discrete locations and/or sections can be associated with one or more user-selected image files. In an embodiment, the system and method can be performed without modifying the media file itself and thus no derivative work is created.

### RELATED APPLICATIONS

This application claims the benefit of U.S. Provisional Application No. 60/722,600, filed Sep. 30, 2005, which application is hereby incorporated herein by reference.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

Multimedia data files, or media files, are data structures that may include audio, video or other content stored as data in accordance with a container format. A container format is a file format that can contain various types of data, possible compressed a standardized and known manner. The container format allows a rendering device to identify, and if necessary, interleave, the different data types for proper rendering. Some container formats can contain only audio data, while other container formation can support audio, video, subtitles, chapters and metadata along with synchronization information needed to play back the various data streams together. For example, an audio file format is a container format for storing audio data. There are many audio-only container formats including known in the art including WAV, AIFF, FLAC, ACC, WMA, and MP3. In addition, there are now a number of container formats for use with combined audio, video and other content including AVI, MOV, MPEG-2 TS, MP4, ASF, and RealMedia to name but a few.

Media files accessible over a network are increasingly being used to deliver content to mass audiences. For example, one emerging way of periodically delivering content to consumers is through podcasting. A podcast is a file, referred to as a “feed,” that lists media files that are related, typically each media file being an “episode” in a “series” with a common theme or topic published by a single publisher. Content consumers can, through the appropriate software, subscribe to a feed and thereby be alerted to or even automatically obtain new episodes (i.e., new media files added to the series) as they become available.

Podcasting illustrates one problem with using media files to deliver mass media through discrete media files. Often, it is desirable to identify a discrete section or sections within a media file. For example, a content consumer may want to identify a section of a news broadcast as particularly of interest or as relating to a topic such as “weather forecast,” “sports,” or “politics.” This is a simple matter for the initial creators of the content, as various data formats support such identifications within the file when the media file is created.

However, it is difficult with current technology to identify a media file or a section or sections within a media file with a given topic after the file has been initially created. In the past, one method of doing this was to edit the media file into smaller portions and place the topic information into the new file name of the smaller portions. Another method is to create a derivative of the original file by editing the file to include additional information identifying the discrete section information.

The methods described above for identifying sections in a pre-existing media file have a number of drawbacks. First, it requires significant effort to edit the media file, whether that be into separate, smaller files or a derivative file with additional information. Second, separate files must be played individually and the sequential relationship to the original master file may be lost. Third, the methods require that the user have the appropriate rights under copyright to make the derivative works. Fourth, now that this new media has been created, is not easily available to the mass market and therefore of limited use.

### SUMMARY OF THE INVENTION

Various embodiments of the present invention relate to a system and method for identifying discrete locations and/or sections within a pre-existing media file with an image file without modifying the media file. The discrete locations and/or sections can be associated with one or more user-selected descriptors. The system and method allows for the identifying information to be communicated to consumers of the media file and the media file to be selectively rendered by the consumer using the identifying information, thus allowing a consumer to render only the portion of the media file identified or render from a given discrete location in the media file. In an embodiment, the system and method can be performed without modifying the media file itself and thus no derivative work is created.

In one example (which example is intended to be illustrative and not restrictive), the present invention may be considered a method of tagging an audio file media file that includes receiving a first selection of the audio file from a first user and further receiving, from the first user, a command to tag the audio file with an image file. Information associating the image file with the audio file is created. The information is interpretable by a rendering device, in response to a command to render the audio file, and causes the rendering device to display the image file when rendering the audio file.

In another example (which example is intended to be illustrative and not restrictive), the present invention may be considered a method of rendering a media file including receiving a command to render the media file by a media file consumer and accessing tag information identifying at least one image associated with the media file by a user after the media file was created. The user need not be the consumer nor the creator of the media file, but may be some unrelated third party. The method further includes determining that the user has associated at least a portion of the media file with the at least one image and concurrently rendering the media file and displaying the at least one image.

In yet another example (which example is intended to be illustrative and not restrictive), the present invention may be considered a method that includes receiving a tag command to associate a pre-existing media file with a pre-existing tag file, in which the media file including renderable media file data and the tag file including renderable tag file data. The method further includes creating metadata interpretable by a rendering device, in which the metadata associates the media file with the tag file. In an embodiment, the media file and the tag file are separate and unrelated files except for the metadata. In response to a render command to the rendering device to render the pre-existing media file, such as a play file command, the rendering device determines that there is metadata associated with the media file and accesses the metadata to identify a location of the media file data. The media file data is retrieved from the location and the tag file data is retrieved from a different location. The method further includes concurrently rendering, by the rendering device, the tag file data and the media file data.

In another example (which example is intended to be illustrative and not restrictive), the present invention may be considered a graphical user interface (GUI) for a rendering device rendering a media file that includes a title display area identifying the media file being rendered. The GUI also includes a tag display area displaying at least one image previously selected by a tag contributor, in which each at least one image associated with the tag contributor that selected the at least one image.

Additional features of the invention will be set forth in the description which follows, and in part will be apparent from the description, or may be learned by practice of the invention. The various features of the invention will be realized and attained by the structure particularly pointed out in the written description and claims hereof as well as the appended drawings. It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of at least one embodiment of the invention.

In the drawings:

FIG. 1 is a high-level illustration of an embodiment of a method of rendering a portion of a pre-existing media file.

FIG. 2 is an illustration of a network architecture of connected computing devices as might be used to distribute and render media files in accordance with one or more embodiments of the present invention.

FIG. 3 is a flowchart of an embodiment of a method of creating a portion definition, in the form of metadata, tagging a portion of a pre-existing media file with an image file.

FIGS. 4a, 4b, 4c and 4d illustrate embodiments of a GUI of a rendering device adapted to tag media files with images.

FIG. 5 is a flowchart of an embodiment of a method of rendering a pre-existing media file tagged with an image.

### DETAILED DESCRIPTION OF EMBODIMENTS OF THE INVENTION

Reference will now be made in detail to illustrative embodiments of the present invention, examples of which are shown in the accompanying drawings.

An embodiment of the present invention includes a system and method for tagging discrete locations and/or sections within a pre-existing media file with images without modifying the media file. The system includes a rendering device that receives user tag selections and creates information that can be used when rendering the media file in the future. When a tagged media file is rendered by a device capable of interpreting the information, the images are concurrently displayed on the interface of the rendering device. The discrete locations and/or sections can be associated with one or more user-selected image files. In an embodiment, the system and method can be performed without modifying the media file itself and thus no derivative work is created.

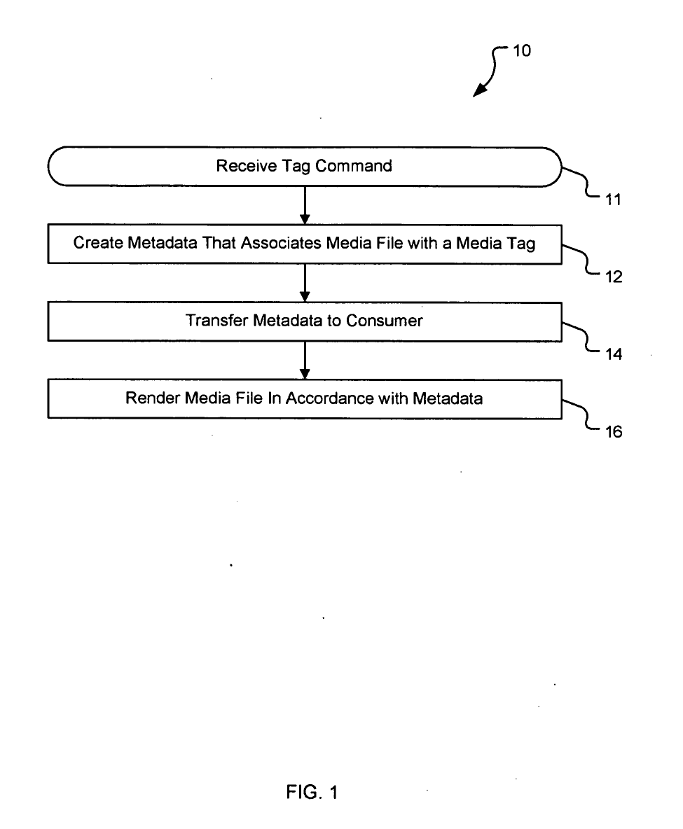

FIG. 1 is a high-level illustration of an embodiment of a method of rendering a portion of a pre-existing media file. In the method 10, a portion definition is created that identifies either a discrete location in the media file or a section within the media file in a create portion definition operation 12. Portion definitions may be created, for example, through use of systems and/or methods as described in commonly-assigned U.S. patent application Ser. No. 11/341,065, titled Identifying Portions Within Media Files with Location Tags, filed Jan. 27, 2006 attorney docket number 85804.021505, which application is hereby incorporated herein by reference. As discussed in greater detail below, in an embodiment the portion definition in the form of metadata is created using a rendering device adapted to create the metadata in response to inputs received from the metadata creator during rendering of the media file. The metadata creator is a user of a rendering device adapted to receive inputs that are used to create the metadata. The metadata creator may be alternatively referred to as a user or a tag contributor when generating the metadata. As part of the create portion definition operation 12, the creator may render the media file on a rendering device, such as using a media player on a computing device or a digital audio player, that is adapted to provide a user interface for generating the portion definition in response to the creator's inputs. In an alternative embodiment, the user may review a timeline, such as the currently existing tags for the media file, instead of rendering the media file on a rendering device.

As also discussed in greater detail below, the portion definition may take many different forms and may include identification metadata that serves to identify a section or location within a pre-existing media file without changing the format of the media file. Thus, a portion definition may be considered as identifying a subset of the media data within a media file, the subset being something less than all of the media data in the media file. For example, identification metadata including a time stamp indicating a time measured from a known point in the media file such as the beginning or end point of the media file. Alternatively, the metadata may identify an internal location identifier in a media file that contains data in a format that provides such internal location identifiers. In yet another alternative embodiment, metadata may include a number, in which the number is multiplied by a fixed amount of time, such as 0.5 seconds for example, or a fixed amount of data, such as 2,352 bytes or one data block for example. In this embodiment, a selection made by the creator results in the next or closest number of the fixed unit is selected for the metadata. One skilled in the art will recognize that various other methods or systems may be used to identify locations in a pre-existing media file, the suitability of which will depend upon the implementation of other elements of the system as a whole.

As mentioned above, the metadata may identify a discrete location in the media file (and thus may be considered to identify the portion of the media file that consists of all the media data in the media file from the discrete location to the end of the media file) or identify any given section contained within a media file as directed by the portion definition creator. Thus, in an embodiment metadata in a portion definition may include a time stamp and an associated duration. Alternatively, the metadata may include two associated time stamps, e.g., a start and a finish. Other embodiments are also possible and within the scope of the present invention as long as the metadata can be used to identify a point or location within a pre-existing media file.

The creator of the portion definition may also choose to associate the location identified with the metadata with a user-selected descriptor, such as word or phrase. These descriptors may be referred to as “tags” for simplicity. For example, the word “weather” may be used as a tag to refer to a section of a media file containing a new report, in which the section is the local weather forecast. One or more tags may be associated with any given metadata section or location identifier. Depending on the implementation, the tag or tags themselves may be considered a separate and distinguishable element of the metadata.

Embodiments of the present invention allow the user to tag the media file or a location within the media file with a picture. When selecting a tag to be associated with the media file or a portion thereof, the user may select an image file to be used as a tag. The user may select a file from local files available on the user's rendering device or may select a file on a remote device to which the user's device has access. A “browse” utility may be used to assist the user in finding and selecting a file in the same manner that electronic mail attachments may be identified.

The image file selected, or alternatively, a location identifier such as a URL of the image file, may then be incorporated into the metadata. This information may be used as additional information that can be searched and used to identify the underlying content in the portion's media data. The information may also be displayed to consumers during searching or rendering of the identified portion.

More that one set of metadata may be created and associated with a media file and associated with different tags. Each set of metadata may then independently identify different portions of the same media file. The portions are independently identified in that any two portions may overlap, depending on the creators designation of beginning and end points.

The metadata created by the metadata creator is then stored in some manner. Storage may include storing the metadata as a discrete file or as data within some other structure such as a request to a remote computing device, a record in a database, or an electronic mail message. The metadata may positively identify the pre-existing media file through the inclusion of a media file identifier containing the file name of the media file. Alternatively, the metadata may be associated with the media file through proximity in that the media file information and the metadata information must be provided together as associated elements, such as in hidden text in a hyperlink. In yet another alternative, the metadata may be stored in a database as information associated with the media file. In an embodiment, all metadata for a discrete media file may be collected into a single data element, a group of data elements, a database, or a file depending on the implementation of the system.

In order for a consumer to render the media file and simultaneously be presented with the tags including the pictures, the metadata and the media file are made available to the consumer's rendering device in an access media file and metadata operation 14. In an embodiment, the metadata may be transmitted to the consumer's rendering device via an e-mail containing the metadata and a link to the media file on a remote computer. In response to a command to render the e-mailed media file, the rendering device is adapted to interpret the metadata as part of the rendering process.

In an alternative embodiment, the metadata may be provided in response to a request from the user's device to a media server that maintains a database of the metadata. The metadata may then be transmitted to the consumer's rendering device as a metadata file. For example, a user may select a media file at a remote server to render and may be prompted “do you want to see tags associated with this media file.” If the user responds affirmatively, then a request may be sent that retrieves the metadata and tags, including any image files that are associated with the media file to be rendered.

Regardless of how the metadata is transmitted to the rendering device, the rendering device is adapted to read the metadata in whatever way it is provided in a render media file operation 16. The render media file operation 16 may be initiated by a user command to render the media file. In response, the rendering device accesses the media file, which may include requesting and retrieving the media from a remote server. In addition, the rendering device also accesses and interprets the metadata associated with the media file to be rendered. If the metadata identifies additional elements, such as image files, that must also be retrieved from a different location on the network, the rendering device requests and retrieves those elements.

The rendering device then renders the media file in accordance with the metadata. In an embodiment, this includes rendering the media file while also displaying a window or other user interface element that contains the tags identified in the metadata. If the tag is a picture, then the picture is displayed in this window when the portion of the media file associated with the tag is being rendered.

The access media file and metadata operation 14 and the rendering operation 16 may occur in response to a consumer command to render the pre-existing media file in accordance with the metadata, e.g., render the section of the media file tagged as “weather” or associated with a picture of the golden gate bridge. Alternatively, none of or only some portion of the copy media file and metadata operation 14 may occur prior to an actual receipt of a consumer command to render the media file in accordance with the metadata.

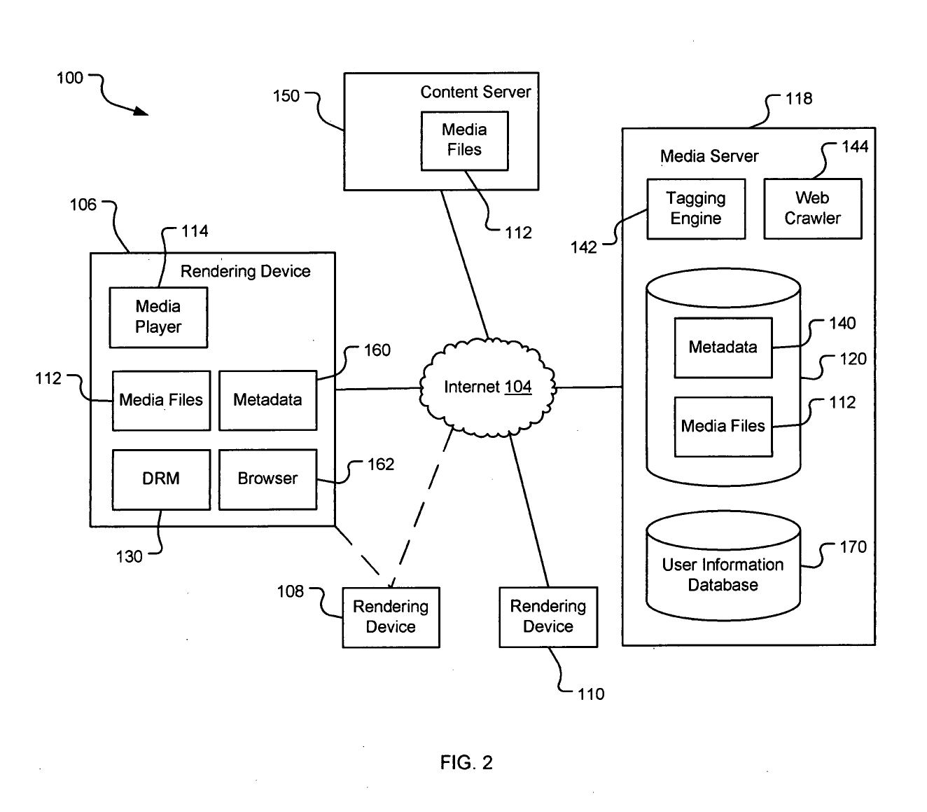

FIG. 2 is an illustration of a network architecture of connected computing devices as might be used to distribute and render media files as described above. In the architecture 100, the various computing devices are connected via a network 104. One example of a network 104 is the Internet. Another example is a private network of interconnected computers.

The architecture 100 further includes a plurality of devices 106, 108, 110, referred to as rendering devices 106, 108, 110, capable of rendering media files 112 or rendering streams of media data of some format. Many different types of devices may be rendering devices, as long as they are capable of rendering media files or streaming media. A rendering devices may be a personal computer (PC), web enabled cellular telephone, personal digital assistant (PDA) or the like, capable of receiving media data over the network 104, either directly or indirectly (i.e., via a connection with another computing device).

For example, as shown in FIG. 2, one rendering device is a personal computer 106 provided with various software modules including a media player 114, one or more media files 112, metadata 160, a digital rights management engine 130 and a browser 162. The media player 114, among other functions to be further described, provides the ability to convert information or data into a perceptible form and manage media related information or data so that user may personalize their experience with various media. Media player 114 may be incorporated into the rendering device by a vendor of the device, or obtained as a separate component from a media player provider or in some other art recognized manner. As will be further described below, it is contemplated that media player 114 may be a software application, or a software/firmware combination, or a software/firmware/hardware combination, as a matter of design choice, that serves as a central media manager for a user of the rendering device and facilitates the management of all manner of media files and services that the user might wish to access either through a computer or a personal portable device or through network devices available at various locations via a network.

The browser 162 can be used by a consumer to identify and retrieve media files 112 accessible through the network 104. An example of a browser includes software modules such as that offered by Microsoft Corporation under the trade name INTERNET EXPLORER, or that offered by Netscape Corp. under the trade name NETSCAPE NAVIGATOR, or the software or hardware equivalent of the aforementioned components that enable networked intercommunication between users and service providers and/or among users. In an embodiment, the browser 162 and media player 114 may operate jointly to allow media files 112 or streaming media data to be rendered in response to a single consumer input, such as selecting a link to a media file 112 on a web page rendered by the browser 162.

Another example of a rendering device is a music player device 108 such as an MP3 player that can retrieve and render media files 112 directly from a network 104 or indirectly from another computing device connected to the network 104. One skilled in the art will recognize that a rendering device 106, 108, 110 may be configured in many different ways and implemented using many different combinations of hardware, software, or firmware.

A rendering device, such as the personal computer 106, also may include storage of local media files 112 and/or other plug-in programs that are run through or interact with the media player 114. A rendering device also may be connectable to one or more other portable rendering devices that may or may not be directly connectable to the network 104, such as a compact disc player and/or other external media file player, commonly referred to as an MP3 player, such as the type sold under the trade name iPod by Apple Computer, Inc., that is used to portably store and render media files. Such portable rendering devices 108 may indirectly connect to the media server 118 and content server 150 through a connected rendering device 106 or may be able to connect to the network 104, and thus directly connect to the computing devices 106, 118, 150, 110 on the network. Portable rendering devices 108 may implement location tagging by synchronizing with computing devices 118, 150, 110 on the network 104 whenever the portable rendering devices 108 is directly connected to a computing device in communication with the network 104. In an embodiment, any necessary communications may be stored and delayed until such a direct connection is made.

A rendering device 106, 108, 110 further includes storage of portion definitions, such as in the form of metadata 160. The portion definitions may be stored as individual files or within some other data structure on the storage of the rendering device or temporarily stored in memory of the rendering device for use when rendering an associated media file 112.

The architecture 100 also includes one or more content servers 150. Content servers 150 are computers connected to the network 104 that store media files 112 remotely from the rendering devices 106, 108, 110. For example, a content server 150 may include several podcast feeds and each of the media files identified by the feeds. One advantage of networked content servers is that as long as the location of a media file 112 is known a computing device with the appropriate software can access the media file 112 through the network 104. This allows media files 112 to be distributed across multiple content servers 150. It also further allows for a single “master” media file to be maintained at one location that is accessible to the mass market and thereby allow the publisher to control access. Through the connection to the network 104, rendering devices 106, 108, 110 may retrieve, either directly or indirectly, the media files 112. After the media files 112 are retrieved, the media files 112 may be rendered to the user, also known as the content consumer, of the rendering device 106, 108, 110.

In an embodiment, media files can be retrieved from a content server 150 over a network 104 via a location address or locator, such as a uniform resource locator or URL. An URL is an example of a standardized Internet address usable, such as by a browser 162, to identify files on the network 104. Other locators are also possible, though less common.

The embodiment of the architecture 100 shown in FIG. 2 further includes a media server 118. The media server 118 can be a server computer or group of server computers connected to the network 104 that work together to provide services as if from a single network location or related set of network locations. In a simple embodiment, the media server 118 could be a single computing device such as a personal computer. However, in order to provide services on a mass scale to multiple rendering devices, an embodiment of a media server 118 may include many different computing devices such as server computers, dedicated data stores, routers, and other equipment distributed throughout many different physical locations.

The media server 118 may include software or servers that make other content and services available and may provide administrative services such as managing user logon, service access permission, digital rights management, and other services made available through a service provider. Although some of the embodiments of the invention are described in terms of music, embodiments can also encompass any form of streaming or non-streaming media data including but not limited to news, entertainment, sports events, web page or perceptible audio or video content. It should be also be understood that although the present invention is described in terms of media content and specifically audio content, the scope of the present invention encompasses any content or media format heretofore or hereafter known.

The media server 118 may also include a user database 170 of user information. The user information database 170 includes information about users that is collected from users, such as media consumers accessing the media server 118 with a rendering device, or generated by the media server 118 as the user interacts with the media server 118. In one embodiment, the user information database 170 includes user information such as user name, gender, e-mail and other addresses, user preferences, etc. that the user may provide to the media server 118. In addition, the server 118 may collect information such as what podcasts the user has subscribed to, what media files the user has listened to, what searches the user has performed, how the user has rated various podcasts, etc. In effect, any information related to the user and the media that a user consumes may be stored in the user information database 170.

The user information database 170 may also include information about a user's rendering device 106, 108 or 110. The information allows the media server 118 to identify the rendering device by type and capability.

Media server 118 includes or is connected to a media database 120. The database 120 may be distributed over multiple servers, discrete data stores, and locations. The media database 120 stores various metadata 140 associated with different media files 112 on the network 104. The media database 120 may or may not store media files 112 and for the purposes of this specification it is assumed that the majority, if not all, of the media files 112 of interest are located on remote content servers 150 that are not associated with the media server 118. The metadata 140 may include details about the media file 112 such as its location information, in the form of a URL, with which the media file 112 may be obtained. In an embodiment, this location information may be used as a unique ID for a media file 112.

The metadata 140 stored in the media database 120 includes metadata for portion definitions associated with media files 112. In an embodiment, portion definitions include metadata 140 received by the media engine 142 from users who may or may not be associated with the publishers of the pre-existing media files 112. The metadata of the portion definitions created for pre-existing media files 112 may then be stored and maintained centrally on the media server 118 and thus made available to all users.

To gather and maintain some of the metadata 140 stored in the media database 120, the media server 118 includes a web crawler 144. The web crawler 144 searches the network 104 and may retrieve or generate metadata associated with media files 112 that the web crawler identifies. In many cases, the metadata 140 identified and retrieved by the web crawler 144 for each media file 112 will be metadata provided by the publisher or creator of the original media file 112.

In the embodiment shown, the web crawler 144 may periodically update the information stored in the media database 120. This maintains the currency of data as the server 118 searches for new media files 112 and for media files 112 that have been moved or removed from access to the internet 104. The media database 120 may include all of the information provided by the media file 112 by the publisher. In addition, the media database 120 may include other information, such as portion definitions, generated by consumers and transmitted to the media server 118. Thus, the media database 120 may contain information not known to or generated by the publisher of a given media file 112.

In an embodiment, the media database 120 includes additional information regarding media files 112 in the form of “tags.” A tag is a keyword chosen by a user to describe a particular item of content such as a feed, a media file 112 or portion of a media file 112. The tag can be any word or combination of key strokes. Each tag submitted to the media server may be recorded in the media database 120 and associated with the content the tag describes. Tags may be associated with a particular feed (e.g., a series tag), associated with a specific media file 112 (e.g., an episode tag) or an identified portion of a media file 112. Tags will be discussed in greater detail below.

Since tags can be any keyword, a typical name for a category, such as “science” or “business,” may also be used as a tag and in an embodiment the initial tags for a media file 112 are automatically generated by taking the descriptions contained within metadata within a pre-existing media file 112 and using them as the initial tags for the media file 112. However, note that tags need not be a hierarchical category system that one “drills down” through. Tags are not hierarchically related as is required in the typical categorization scheme. Tags are also cumulative in that the number of users that identify a series or an episode with a specific tag are tracked. The relative importance of the specific tag as an accurate description of the associated content (i.e., series, episode, media file or portion of media file) is based on the number of users that associated that tag with the content.

In an embodiment, consumers of media files 112 are allowed to provide information to be associated with the media file 112 or a portion of the media file 112. Thus the user after consuming media data may rate the content, say on a scale of 1-5 stars, write a review of the content, and enter tags to be associated with the content. All this consumer-generated data may be stored in the media database 120 and associated with the appropriate media file 112 for use in future searches.

In one embodiment, the media engine 142 creates a new entry in the media database 120 for every media file 112 it finds. Initially, the entry may contain some or all of the information provided by the media file 112 itself. An automatic analysis may or may not be performed to match the media file 112 to known tags based on the information provided in the media file 112. For example, in an embodiment some media files 112 include metadata such as a category element and the categories listed in that element for the media file 112 are automatically used as the initial tags for the media file 112. While this is not the intended use of the category element, it is used as an initial tag as a starting point for the generation of more accurate tags for the media file 112. Note that searches on terms that appear in the media file 112 metadata will return that media file 112 as a result, so it is not necessary to provide tags to a new entry for the search to work properly. Initially no ratings information or user reviews are associated with the new entry. The manager of the media server may solicit additional information from the publisher such as the publisher's recommended tags and any additional descriptive information that the publisher wishes to provide but did not provide in the media file 112 itself.

The media database 120 may also include such information as reviews of the quality of the feeds, including reviews of a given media file 112. The review may be a rating such as a “star” rating and may include additional descriptions provided by users. The media database 120 may also include information associated with publishers of the media file 112, sponsors of the media file 112, or people in the media file 112.

The media server 118 includes a media engine 142. In an embodiment, the media engine 142 provides a graphical user interface to users allowing the user to search for and render media files 112 and portions of media files 112 using the media server 118. The graphical user interface may be an .HTML page served to a rendering device for display to the user via a browser. Alternatively the graphical user interface may be presented to the user through some other software on the rendering device. Examples of a graphical user interface presented to a user by a browser are discussed with reference to FIGS. 11-13. Through the graphical user interface, the media engine 142 receives user search criteria. The search engine 142 then uses these parameters to identify media files 112 or portions of media files 112 that meet the user's criteria. The search may involve an active search of the network, a search of the media database 120, or some combination of both. The search may include a search of the descriptions provided in the media files 112. The search may also include a search of the tags and other information associated with media files 112 and portions of the media files 112 listed in the media database 120, but not provided by the media files themselves. The results of the search are then displayed to the user via the graphical user interface.

In one embodiment of the present invention, similar to the DRM software 130 located on a rendering device 106, the media server may maintain its own DRM software (not shown) which tracks the digital rights of media files located either in the media database 120 or stored on a user's processor. Thus, for example, before the media server 118 streams or serves up or transfers any media files to a user, it validates the rights designation of that particular piece of media and only serves streams or transfers the file if the user has the appropriate rights.

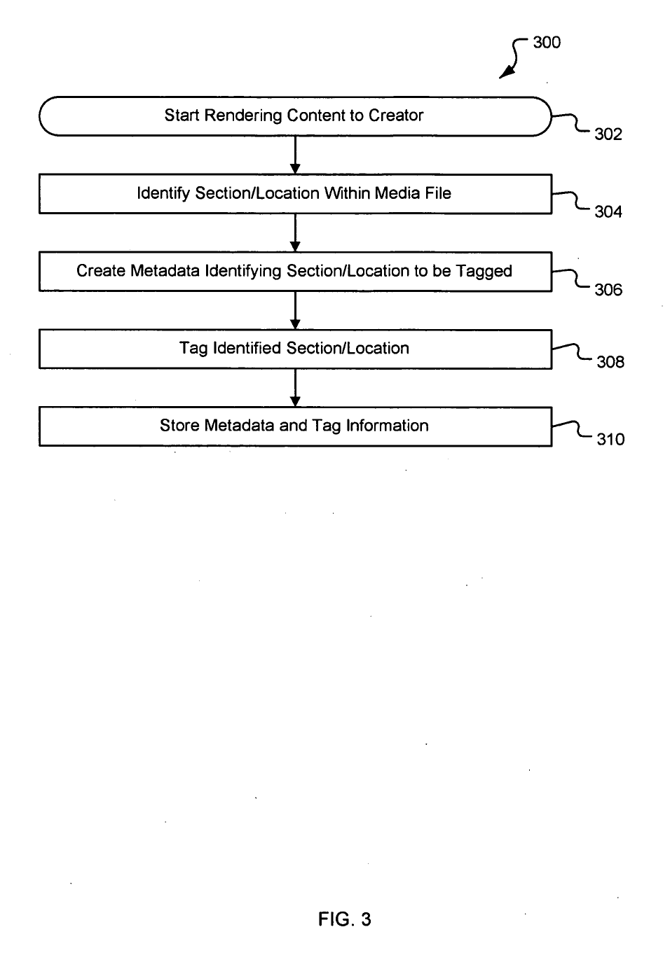

FIG. 3 is a flowchart of an embodiment 300 of a method of creating a portion definition, in the form of metadata, tagging a portion of a pre-existing media file with an image file. In the method 300 shown, the creator starts play back of a selected media file using a rendering device capable of capturing the metadata in an initiate rendering operation 302.

During the rendering, the creator issues a request to the rendering device to select a portion of the media file in an identify portion operation 304. In an embodiment, the identify portion operation 304 includes receiving a first command from the creator during rendering of the media file identifying the starting point and receiving a second command from the creator identifying an endpoint of the portion of the media file.

In an alternative embodiment, the creator issues one request that selects one discrete location of the media file in the identify portion operation 304. In this embodiment, only a first command from the creator is received during rendering of the media file identifying the location point within the media file.

From these commands and information provided by the creator, a first set of metadata may be created in a create metadata operation 306. Depending on the implementation, the metadata may be created on creator's rendering device or created on a media server remote from the rendering device as discussed above.

The identified portion may be associated with some description in a tag operation 308. In an embodiment, the rendering device may prompt the creator to enter one or more tags to be associated with the identified portion. In an alternative embodiment, the creator may enter the tag as part of an initial request to create a portion definition for the media file. One or more tags may be used to identify the portion. A tag may consist of text in the form of one or more words or phrases.

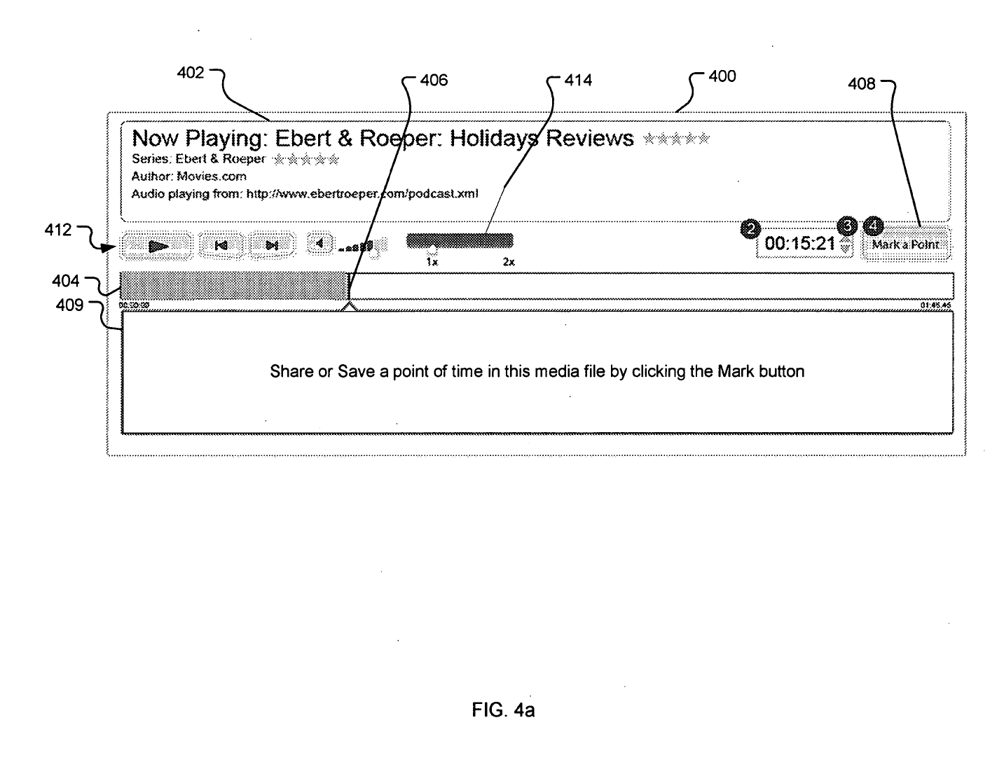

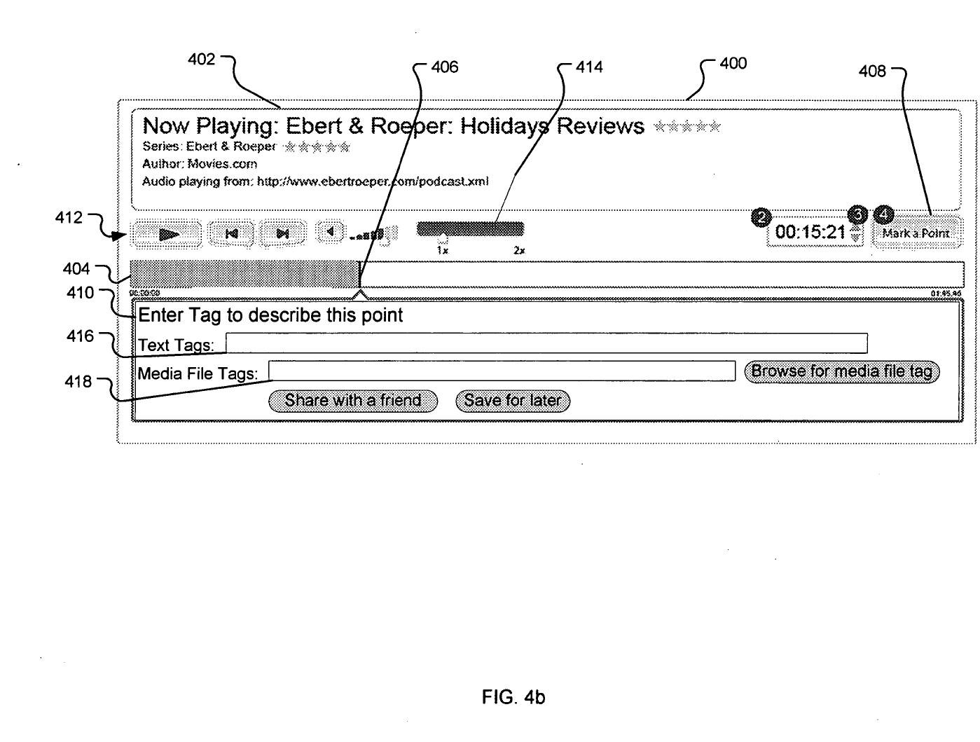

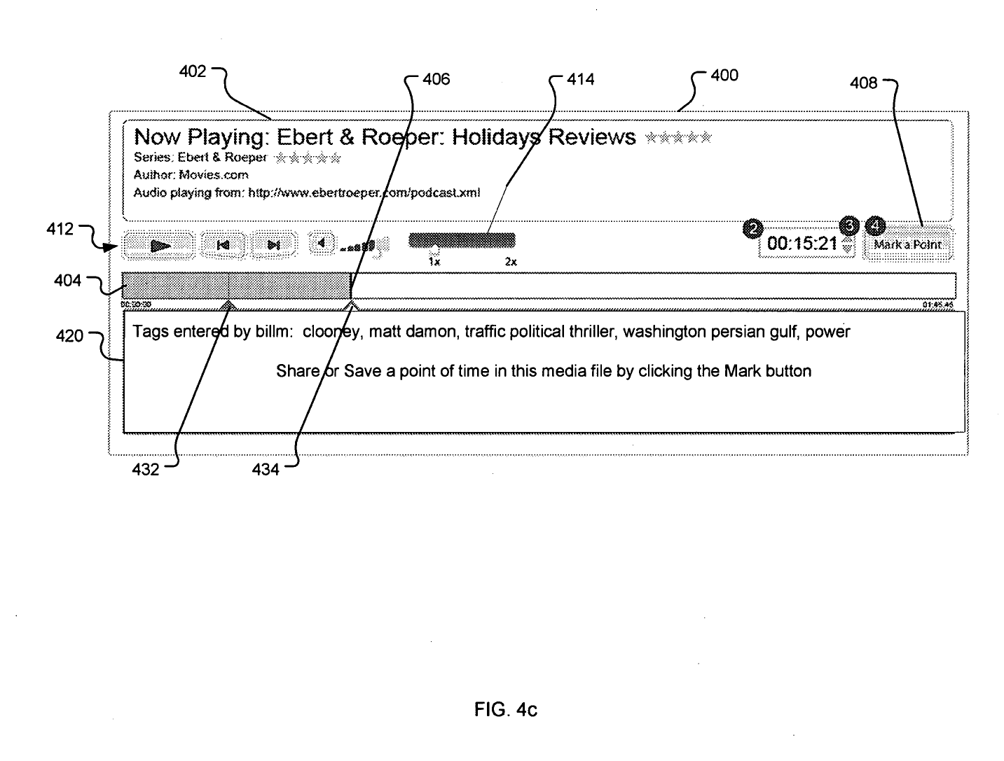

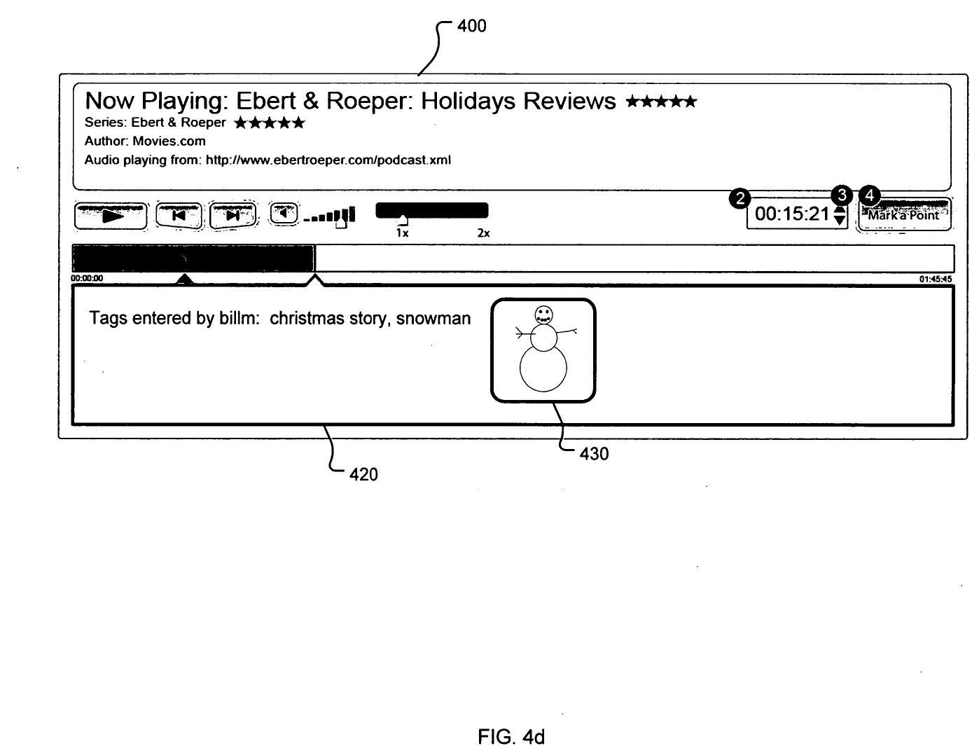

The tag operation 308 also presents to the user a graphical user interface (GUI), such as that discussed with reference to FIG. 4 below, that allows the tag creator to enter a file name or to select files to be associated with the location. For example, the GUI may allow the creator to browse the rendering device and accessible computing devices for files to be associated with the location. Thus, the creator may select a second file to be used as a tag in association with the media file so that the tag may be associated with the entire media file or may be associated with only a location or specified portion of the media file.

The types of files that may be selected may be limited. For example, only image file types, such as jpg, gif, ico or .vsd file, may be selectable. File selection may also be limited based on a size restriction so that files of too big a size may not be selected.

The limitations may be determined based on the file type of the media file to which the tag is to be associated. For example, the system may distinguish between media files that are rendered over time, such as audio (e.g., songs) and video (e.g., movies), and media files that are static, such as pictures, text, images. The system may limit tags for time-rendered media files to only static tags. The system, however, may allow static media file to be tagged with time-rendered media files. In that way, a picture may be tagged with an audio commentary on the picture so that when the picture is rendered on the rendering device the audio commentary of the tag is also rendered.

Such tag limitations may be enforced at the time of tag selection by the creator. Thus, if the creator attempts to select a file type, for example, the GUI may return an error message, possibly explaining why the file type is not allowed to be used as a tag.

The tag or tags are selected by the creator and the selection is received via the creator's interface with the rendering device. Depending on the implementation, the tag or tags may be used to create tag information on the creator's rendering device or on a media server remote from the rendering device as discussed above.

The metadata and tag information are then stored in a store operation 310. Again, depending on the implementation, the metadata and tag information may be stored on the creator's rendering device or stored on a media server remote from the rendering device. In any case, the data is stored in such a way as to associate the metadata and tag information with the media file. For example, in an embodiment the metadata may include the name of the media file and the tags identified by the creator. In another embodiment, the name and location of the media file, the metadata and each tag may be stored in separate but associated records in a database. Other ways of associating the media file, metadata and tag information are also possible depending on the implementation of the system.

Method 300 is suitable for use with a pre-existing media file created without anticipation of such tagging. Method 300 is also suitable for adding one or more portion definitions to a media file that may already include or be associated with one or more previously created portion definitions.

FIGS. 4a, 4b, 4c and 4d illustrate embodiments of a GUI of a rendering device. The GUI 400 may be used for tagging a media file with a second file, such as an image file, as well as displaying different tags associated with different portions, or sections, of a media file. In the embodiment shown, a media file is being rendered to the tag creator. The GUI 400 may be provided and displayed by media player software executing on the rendering device or may be provided by a media engine executing on a media server and displayed at the rendering device via a browser. In an embodiment, the GUI 400 includes controls in the form of text boxes, drop down menus and user selectable buttons to allow the searching for media files in addition to information display areas.

In the embodiments shown in FIGS. 4a-4d, the media file name is shown in a Now Playing title area 402 of the GUI 400. This is the media file that selected tags will be associated with. In the embodiment shown, the title area 402 includes the title of the media file, which in the example shown is episode of the Ebert & Roeper podcast. The title area also identifies the podcast, the author of the media file and the location from which the media file was obtained, which in the embodiment shown is a remote server location.

The GUI also includes a set of render control elements 412 including a play/pause button, next and previous buttons, a volume control and a playback speed control 414. These controls, along with the timeline 404 and the selectable location slider 406, allow the creator to control the rendering, e.g., playback, of the media file.

A second area of the GUI is a timeline 404 showing the progress of the rendering through the media file. A moving location point 406 shows the current location. In addition, the previously played portion of the media file is shown on the timeline with a different color to further assist the creator in visually identifying the currently rendering point within the data of the media file. The location point 406 is also a user selectable slider allowing the tag creator to initiate rendering from any point in the media file.

The GUI shown in FIG. 4a also includes a tag area 409. If tags already exist for this media file, they would be shown in this area 409. In the embodiment shown, there are no tags known to the rendering device and the tag area 409 displays a prompt message to the creator alerting the creator of the tagging functionality of the GUI 400.

The GUI also includes a “mark a point” interface element in the form of a button 408. In an embodiment, user selection of the mark a point button 408 on FIG. 4a causes the “enter tag” area 410 on FIG. 4b to be displayed as shown. In an alternative embodiment, the mark a point button 408 may be omitted and the “enter tag” area 410 displayed at all time or in response to some other user input.

The tag entry area 410 includes a text entry textbox 416 for entering textual tags such as words or phrases. After entering a tag in the textbox 416, the creator creates the metadata by selecting either the “share with friend” button 418 or the “save for later” button 420. Selecting the “share with friend” button 418 causes the tag entry area 410 to change into an email address entry area (not shown) in which the creator may enter electronic mail addresses and send the metadata to the entered addressees. The “save for later” button 420 causes the tag entry area 410 to change to a tag display area 420 as shown in FIG. 4c.

The tag entry area 410 also includes a file name entry textbox 418 for entering the file name of a file to be associated with the specified point in the media file. In addition, a browse button 422 is provide that, upon user selection, displays a file manager interface (not shown) to the creator through which the creator can find and select a file accessible to the rendering device. In addition, the GUI may support a drag-and-drop method of selecting a file and dropping it into the file name entry textbox 418. As described above with reference to FIG. 3, user entry of a file name in the file name entry textbox 418 and selection of either the “share with friend” button 418 or the “save for later” button 420 results in the creation of the metadata for the media file. This may include the transmission of the file identified in the name entry textbox 418 to the media server database. Depending on the embodiment, it may also include the generation metadata containing or referring to the file.

The tag display area 420 in FIG. 4c displays tags associated with different points in the media file. In the embodiment shown, text tags have been entered by a creator identified as “billm”. The tag display area 420 includes all the tags created by billm to identify the point in the media file. In the embodiment shown, there are two tagged locations in the media file identified by the triangular indicia 432, 434 which act as user selectable tabs. Thus, the tag display areas 420 for each location may be considered a separate tabbed page, with the tab graphically indicating the location in the timeline of the tagged location.

The tag display area 420 may identify and display tags from more than one source. In one embodiment, not shown, a drop down box is provided allowing the viewer of the tagged media file to select from the drop down box any one of the tag creators by name. Selection of a tag creator's name will cause the GUI 400 to be updated to display the tags and tag locations identified by that creator. Through additional controls the GUI may allow the viewer to filter the tags displayed by tag creator, such as by allowing the viewer select only a subset of tag creators to display tags for. In the same manner, an additional control may be provided to allow the user to display the points that have been tagged by specific tag creators. For example, in an embodiment the user may move a pointing device over the timeline 404, which causes a point display popup window (to be displayed to the user allowing the user to select any of the tag creators by name and display the tagged points only of that tag creator.

FIG. 4d illustrates the GUI when a previous tag creator has tagged the media with a file tag. In the embodiment shown, the tag is a picture 430 of a snowman. The picture 430 is displayed in the tag display area 420 along with the text tags selected by the same tag creator. In an embodiment, the file tag may be reduced in size to fit the current size of the tag display area 420. Alternatively, the size of the display area 420 may be enlarged to fit the file tag. In yet another alternative embodiment, the file tag may be displayed in a separate window (not shown) that is separate from the window containing the GUI 400.

A user of a rendering device that includes the GUI 400 described above may be both a tag contributor (e.g., the user uses the GUI 400 to tag the media file) and also a consumer of the media file in that the user is also presented with the tags previously associated with the media file by previous tag contributors.

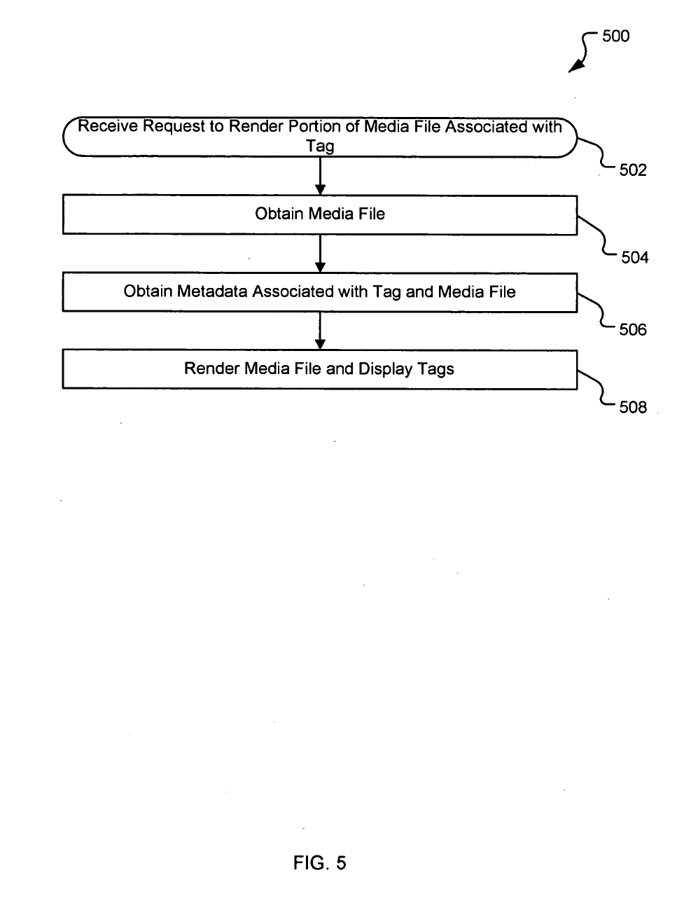

FIG. 5 is a flowchart of an embodiment 500 of a method of rendering a pre-existing media file tagged with a picture. The method 500 shown starts with the receipt of a command by a consumer to render only a portion of a pre-existing media file in a receive render request operation 502. The request may be generated by the consumer selecting, e.g., clicking on, a link on a web page displayed by a browser. Alternatively, the request may be generated by a consumer opening a file, such as a file written in .XML or some other markup language, that can be interpreted by a rendering device. Such a link or file for generating the request may display information to the consumer such a tag associated with the portion to be rendered.

In an embodiment, the request includes data that identifies the media file and also identifies metadata that can be interpreted to identify a portion of the media file. The metadata can be incorporated into the request itself or somehow identified by the request so that the metadata can be obtained. The request may also include tag information for identifying the metadata and thus identifying the portion of the media file to be rendered.

After receiving the request, the media file must be obtained in an obtain media file operation 504 unless the media file has already been obtained. Obtaining the media file may include retrieving the file from a remote server using a URL passed in the request. It should be noted that the media file is a pre-existing file that was created independently of the metadata or any tag information used in the method 500 to render only a portion of the media file.

The portion definition must also be obtained in an obtain metadata operation 506 unless the metadata is already available. For example, if the metadata was provided as part of the request to render, then the metadata has already been obtained and the obtain metadata operation 506 is superfluous. In an embodiment, the request received contains only some identifier which can be used to find the metadata, either on the rendering device or on a remote computing device such as a remoter server or a remote media server. In the embodiment, the metadata is obtained using the identifier. In an embodiment in which the picture or other file that is a tag is not part of the metadata, the file is accessed using file identification information in the metadata.

The media file is then rendered to the consumer in a render operation 510. As the media file is rendered, the metadata is used to determine if the section of the media file being rendered is associated with any tags. In an embodiment, tags may be assigned to a single location, but considered associated with all media data (i.e., the section of media data) between that location and the next temporal location tagged by the tag creator. If the section is associated with a tag, the tag may be displayed to the consumer as part of the render operation 510.

It should be noted that the steps described above may be performed on a rendering device or a media server in any combination. For example, the request may be received by a rendering device which then obtains the metadata and media files, interprets the metadata and renders only the portion of the media file in accordance with the metadata. Alternatively, the request could be received by the rendering device and passed in some form or another to the media server (thus being received by both). The media server may then obtain the media file and the metadata, interpret the metadata and render the media file by transmitting a data stream (containing only the portion of the media file) to the rendering device, which then renders the stream. In this embodiment, only the receiving operation 502 and the rendering operation 510 can be said to occur, in whole or in part, at the rendering device.

Other embodiments are also contemplated. In an embodiment, the media server serves as a central depository of tag files. The tag files may be sent with metadata or included with metadata whenever a tagged media file is accessed by a user of the system.

In response to a request from a rendering device to the media server, the media server may respond by transmitting the metadata and picture tag file only if the rendering device is capable of interpreting it. Note that a tag file may need to be modified or collected into a format that the rendering device can interpret. If the rendering device is not capable of interpreting the tag file, the media server may then retrieve the media file and stream the identified media data and the tag to the rendering device. This may include querying the rendering device to determine if the rendering device is capable of interpreting a tag file of a specific type or performing some other operation to determine which method to use, such as retrieving user information from a data store or inspecting data in the request that may include information identifying the capabilities of the rendering device, e.g., by identifying a browser, a media player or device type.

In another alternative embodiment, a consumer may select to obtain and indefinitely store a copy of the associated pre-existing media file on the consumer's local system. A rendering device may then maintain information indicating that the local copy of the pre-existing media file is to be used when rendering the portion in the future. This may include modifying metadata stored at the rendering device or periodically retrieving metadata from the media server.

While the invention has been described in detail and with reference to specific embodiments thereof, it will be apparent to those skilled in the art that various changes and modifications can be made therein without departing from the spirit and scope thereof. Thus, it is intended that the present invention cover the modifications and variations of this invention provided they come within the scope of the appended claims and their equivalents.

What is claimed is:

1. A method comprising:
receiving a first selection of an audio file from a first user;
receiving, from the first user, a command to tag the audio file with an image file;
creating information associating the image file with the audio file, the information interpretable by a rendering device, in response to a command to render the audio file, and causing the rendering device to display the image file when rendering the audio file.

2. The method of claim 1 wherein the audio file and image file are stored separately at different locations remote from the rendering device.

3. The method of claim 1 further comprising:
transmitting the information to the rendering device.

4. The method of claim 1 further comprising:
storing the information at a media server remote from the audio file; and
transmitting, by the media server, the information to rendering devices in response to requests from the rendering devices to rendering the audio file.

5. The method of claim 1 further comprising:
combining the information with pre-existing information previously generated by one or more second users.

6. A method of rendering a media file comprising:
receiving a command to render the media file;
accessing tag information identifying at least one image associated with the media file by a user after the media file was created;
determining that the user has associated at least a portion of the media file with the at least one image; and
concurrently rendering the media file and displaying the at least one image.

7. The method of claim 6 further comprising:
retrieving the media file from a first remote location;
retrieving the at least one image from a second remote location; and
retrieving the tag information from a third remote location.

8. The method of claim 6 further comprising:
in response to receiving the command, querying a database for tag information associated with the media file.

9. The method of claim 8 further comprising:
retrieving the tag information from the database including a first identifier of the image and a second identifier of the user that associated the image with the media file.

10. The method of claim 6 further comprising:
displaying an identifier of the user when displaying the at least one image.

11. A method comprising:
receiving a tag command to associate a pre-existing media file with a pre-existing tag file, the media file including renderable media file data and the tag file including renderable tag file data;
creating metadata interpretable by a rendering device, the metadata associating the media file with the tag file; and
in response to a render command to the rendering device to render the pre-existing media file,
accessing the metadata to identify a location of the media file data;
retrieving the media file data from the location;
retrieving the tag file data from a different location; and
concurrently rendering, by the rendering device, the tag file data and the media file data.

12. The method of claim 11 wherein the tag command is a command to associate the tag file with a specified subset of media file data and concurrently rendering further comprises:
rendering the media file data on the rendering device; and
when rendering the specified subset of media file data, concurrently rendering the tag file data.

13. The method of claim 12 wherein creating further comprises:
creating metadata that identifies the subset of media file data to the rendering device.

14. The method of claim 11, wherein creating further comprises:
accessing the media file data; and
including at least some of the media file data as metadata.

15. The method of claim 11 further comprising:
transmitting the metadata with the tag file to the rendering device.

16. The method of claim 15 further comprising:
transmitting the media file data to the rendering device.

17. The method of claim 11 wherein the tag file contains an image and rendering further comprises:
concurrently displaying the image and rendering the media file.

18. The method of claim 11 wherein the tag file and the media file are not modified.

19. The method of claim 11 wherein the media tag and the pre-existing media file are separate and independently renderable media files associated to each other only by the metadata.

20. A graphical user interface (GUI) for a rendering device rendering a media file comprising:
a title display area identifying the media file being rendered; and
a tag display area, the tag display area displaying at least one image previously selected by a tag contributor, each at least one image associated with the tag contributor that selected the at least one image.

21. The GUI of claim 20 further comprising:
a tag file textbox for receiving an image file identifier; and
a first user control that, when selected by a user of the rendering device, creates information that causes the rendering device to display, in the tag display area, a second image identified by the image file identifier.

22. The GUI of claim 21 further comprising:
a second user control that, when selected by a user of the rendering device, creates the information and displays a address textbox for receiving an address to send the information to.

23. The GUI of claim 20 further comprising:
a timeline area displaying the current render location within the media file being rendered; and
the tag display area displaying tags associated only with the current render location displayed in the timeline area.

24. The GUI of claim 23 further comprising:
the timeline area displaying a tag identifier identifying each tagged location in the media file.

25. The GUI of claim 20 further comprising:
the tag display area displaying the tag contributors the at least one image.

26. The GUI of claim 20 further comprising:
a third user control that causes the first user control, the second user control and the tag file textbox to be displayed on the GUI.
